(19) United States
(12) Patent Application Publication
(10) Pub. No.: US 2025/0385023 A1
(43) Pub. Date: Dec. 18, 2025

(54) CORE WIRE AND CABLE INCLUDING THE CORE WIRE

(71) Applicants: Foxconn (Kunshan) Computer Connector Co., Ltd., Kunshan (CN); Foxconn Interconnect Technology Limited, Grand Cayman (KY)

(72) Inventors: YU GONG, Huaian (CN); A-Nan Yang, Huaian (CN); Han-Run Xie, Huaian (CN); Lu-Yu Chang, New Taipei (TW)

(21) Appl. No.: 19/238,734

(22) Filed: Jun. 16, 2025

(30) Foreign Application Priority Data
Jun. 14, 2024 (CN) 202421366114.3

(51) Int. Cl. H01B 7/02; H01B 7/18

(52) U.S. Cl. CPC H01B 7/0216; H01B 7/1805

(57) ABSTRACT

A cable includes: a core wire comprising a pair of inner conductors; and an insulating layer covering the pair of inner conductors; and a shielding layer disposed outside the insulating layer; wherein an outer surface of the insulating layer is wavy so that an air gap is formed between the shielding layer and a wave trough of the insulating layer.

### BACKGROUND OF THE INVENTION

### FIELD OF THE INVENTION

The present invention relates generally to a core wire for a cable, and a cable including the core wire, and more particularly to a core wire that has good electrical performance to transmit high-frequency signals.

### Description of the Related Arts

With the development and popularization of electronic technology products, cables are widely used in household appliances, instrumentation, automation equipment, data centers, servers, switches, cloud computing and 5G as a tool for signal transmission. The core wire of the cable generally comprises an inner conductor and an insulating layer covering the inner conductor. The insulating layer is usually made of foam material to reduce the dielectric constant and size of the cable. However, the insulating layer made by traditional foaming technology is not foamed uniformly, which affects the stability of high-frequency signal transmission.

Therefore, it is desired to provide an improved core wire with a lower dielectric constant and stable signal transmission.

### SUMMARY OF THE INVENTION

A main object of the present invention is to provide a cable wire with good electrical performance to transmit high-frequency signals and a core wire used in the cable.

To achieve the above object, a cable includes: a core wire comprising a pair of inner conductors; and an insulating layer covering the pair of inner conductors; and a shielding layer disposed outside the insulating layer; wherein an outer surface of the insulating layer is wavy to form an air gap between the shielding layer and the insulating layer.

To achieve the above object, a core wire includes: a pair of inner conductors; and an insulating layer being made of a solid material and covering the pair of inner conductors; wherein an outer surface of the insulating layer is wavy for being wrapped by a shielding layer to form an air gap.

Compared to prior art, the outer surface of the insulating layer of the core wire of the present invention is wavy, so that an air gap is formed between the shielding layer and a wave trough of the insulating layer, the dielectric constant of the cable is low, and signal transmission is more stable.

### BRIEF DESCRIPTION OF THE DRAWING

FIG. 1 is a cross-sectional view of a first embodiment of a core wire of the present invention;

FIG. 2 is a cross-sectional view of a second embodiment of a core wire of the present invention;

FIG. 3 is a cross-sectional view of a third embodiment of a core wire of the present invention;

FIG. 4 is a cross-sectional view of a forth embodiment of a core wire of the present invention;

FIG. 5 is a cross-sectional view of a fifth embodiment of a core wire of the present invention;

FIG. 6 is a cross-sectional view of a sixth embodiment of a core wire of the present invention; and

FIG. 7 is a cross-sectional view of a cable using the core wire of the second embodiment of the present invention.

### DETAILED DESCRIPTION OF THE PREFERRED EMBODIMENT

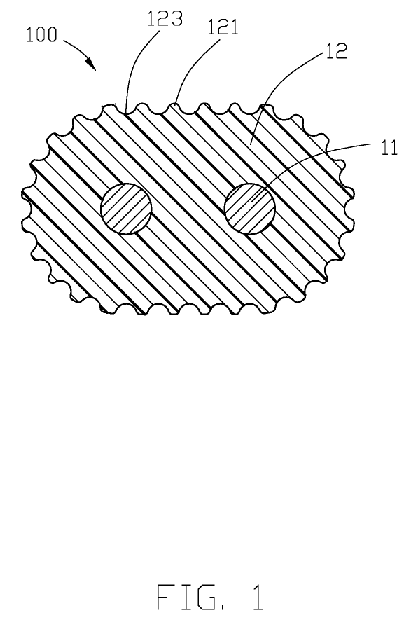

Referring to FIG. 1, the first embodiment of the core wire 100 of the present invention is shown. The core wire 100 comprises a pair of inner conductors 11, an insulating layer 12 covering the pair of inner conductor 11. The outer surface of the insulating layer 12 is concave-convex. Specifically, the outer surface of the insulating layer 12 is wavy. The wavy includes a plurality of wave crests 121 protruding outward and a plurality of wave troughs 123 concave inward. The wave crests 121 and the wave troughs 123 are evenly arranged along the outer surface of the insulating layer 12. The shapes of each wave crest 121 is the same, and the shapes of the wave trough 123 is the same. The insulating layer 12 is made of solid material to improve the mechanical strength of the core wire 100.

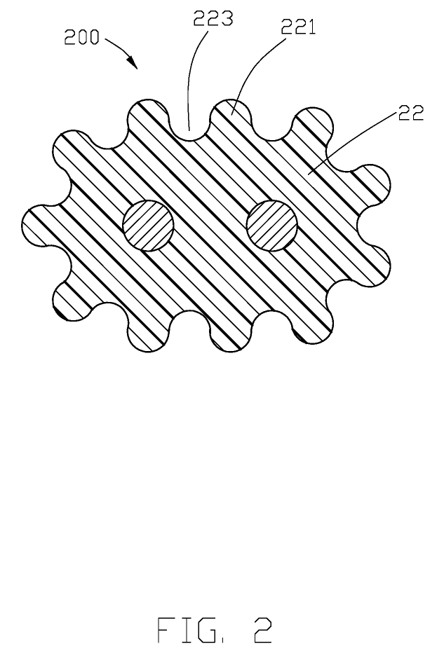

FIG. 2 shows the second embodiment of a core wire 200 of the present invention. Compared with the first embodiment, in this embodiment, the size of the wave crest 221 and the wave trough 223 on the insulating layer 22 is larger. The wave crest interval and wave trough depth can be freely adjusted according to needs.

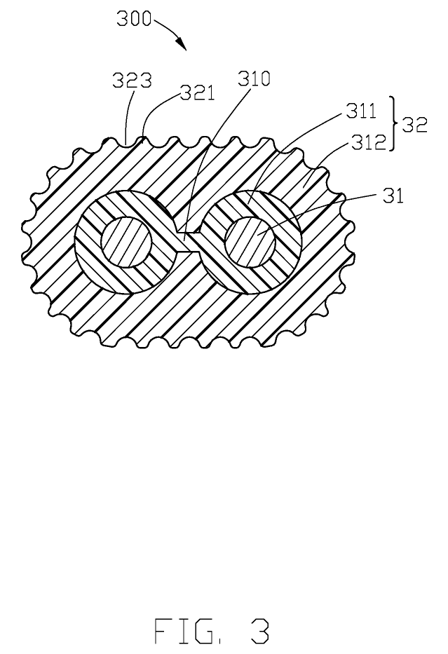

FIG. 3 shows the third embodiment of a core wire 300 of the present invention. Compared with the first embodiment, in this embodiment, the insulating layer 32 includes a first insulating layer 311 and a second insulating layer 312. The material of the first insulating layer 311 may be different from the material of the second insulating layer 312. The first insulating layer 311 is covered on the pair of inner conductors 31 by extrusion molding. The first insulating layer 311 is commonly extruded and formed on the pair of inner conductors 31 to have an 8-shaped outer shape. The first insulating layer 311 includes a connecting portion 310 located between the pair of inner conductors 31.

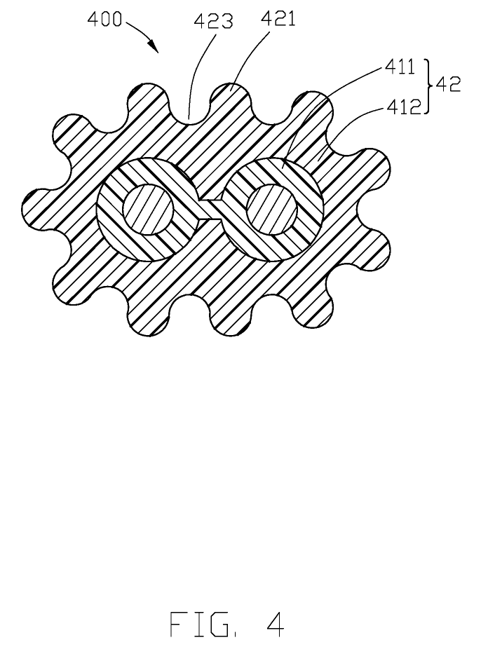

FIG. 4 shows the fourth embodiment of a core wire 400 of the present invention. Compared with the third embodiment, in this embodiment, the size of the wave crest 421 and the wave trough 423 on the outer surface of the second insulating layer 412 of the insulating layer 42 is larger, and the depth of the wave trough 423 is smaller than the outer surface of the first insulating layer 411.

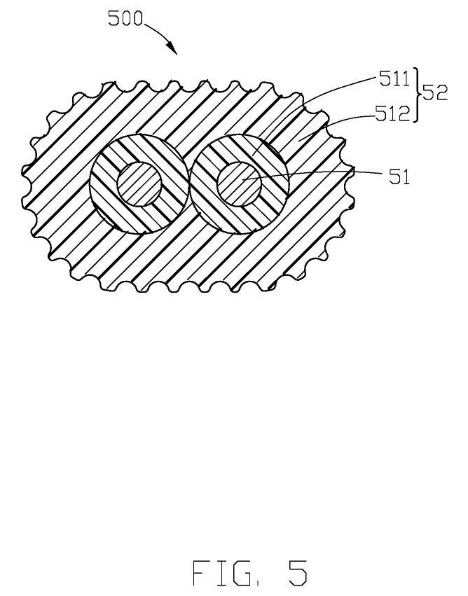

Referring to FIG. 5 shows the fifth embodiment of a cable 500 of the present invention. Compared with the third embodiment, in this embodiment, the first insulating layers 511 of the insulating layer 52 is respectively extruded outside the corresponding inner conductor 51, and the surfaces of the first insulating layers 511 on the pair of inner conductors 51 are in contact with each other. The second insulating layer 512 commonly covers the first insulating layers 511 outside the pair of inner conductors 51.

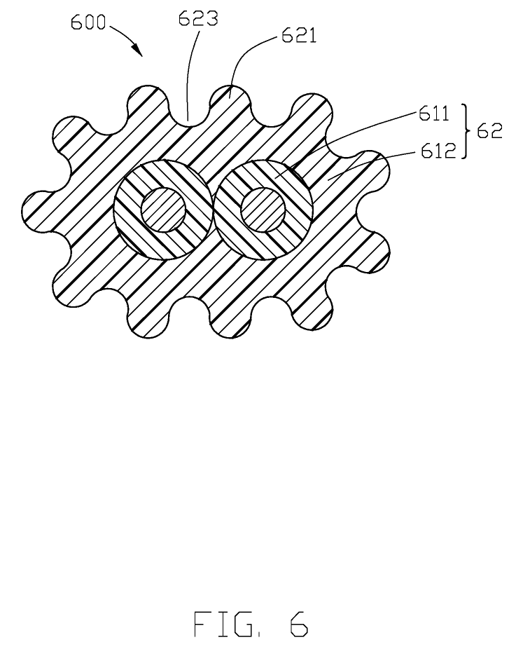

FIG. 6 shows the sixth embodiment of a core wire 600 of the present invention. Compared with the fifth embodiment, in this embodiment, the size of the wave crest 621 and the wave trough 623 of the outer surface of the second insulating layer 612 of the insulating layer 62 is larger, and the depth of the wave trough 623 is smaller than the outer surface of the first insulating layer 611.

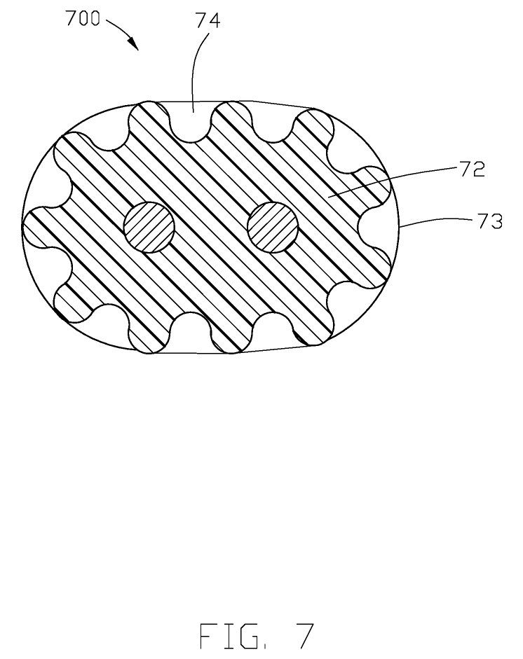

FIG. 7 shows a cable 700 using the core wire of the second embodiment of the the present invention, a metal shielding layer 73 is wrapped around the insulating layer 72, since the outer surface of the insulating layer 72 of the core wire is concave-convex, an air gap 74 is formed between the shielding layer 73 and each of the wage troughs of the insulating layer 72.

The cable made of the core wire of the present invention forms an air gaps between the shielding layer and a recessed portion of the insulating layer, which can reduce the dielectric constant and capacitance effect of the cable. The dielectric constant of air is 1~1.2, which is lower than other materials, this can speeds up the transmission rate of electromagnetic waves, reduces the attenuation loss of cables when transmitting high-frequency signals, and improves the overall electrical performance of the cable. In addition, compared with the traditional insulating layer formed by foaming, the uniformity of pores is difficult to ensure, the insulating layer of the present invention is precisely processed by extrusion mold, so that the proportion of hollow pores tends to be stable, the cable of the present invention has great advantages.

1. A cable comprising:
a core wire comprising
a pair of inner conductors; and
an insulating layer covering the pair of inner conductors; and
a shielding layer disposed outside the insulating layer; wherein an outer surface of the insulating layer is wavy to form an air gap between the shielding layer and the insulating layer.

2. The cable as claimed in claim 1, wherein the wavy outer surface comprises a plurality of wave crests protruding outward and a plurality of wave troughs concave inward, the wave crests and the wave troughs are evenly arranged, the shapes of the plurality of wave crests are identical, and the shapes of the plurality of wave troughs are identical.

3. The cable as claimed in claim 2, wherein the insulating layer includes a first insulating layer and a second insulating layer covering the first insulating layer.

4. The cable as claimed in claim 3, wherein the material of the first insulating layer is different from the material of the second insulating layer.

5. The cable as claimed in claim 3, wherein the first insulating layer is over the pair of inner conductors and includes a connecting portion located between the pair of inner conductors.

6. The cable as claimed in claim 3, wherein the first insulating layer has two parts each over a corresponding one of the pair of inner conductors, and the two parts are in contact with each other.

7. The cable as claimed in claim 3, wherein the second insulating layer completely covers the first insulating layer.

8. The cable as claimed in claim 1, wherein the insulating layer is made of solid material.

9. A core wire comprising:
a pair of inner conductors; and
an insulating layer being made of a solid material and covering the pair of inner conductors; wherein
an outer surface of the insulating layer is wavy for being wrapped by a shielding layer to form an air gap.

10. The core wire as claimed in claim 8, wherein the wavy outer surface comprises a plurality of wave crests protruding outward and a plurality of wave troughs concave inward, the wave crests and the wave troughs are evenly arranged, the shapes of the plurality of wave crests are identical, and the shapes of the plurality of wave troughs are identical.
